(19) United States
(12) Patent Application Publication
(10) Pub. No.: US 2014/0269259 A1
(43) Pub. Date: Sep. 18, 2014

(54) COMMUNICATION SYSTEM FOR MANAGING LEASED LINE NETWORK WITH WIRELESS FALLBACK

(71) Applicant: CENTRE FOR DEVELOPMENT OF TELEMATICS (C-DOT), Bangalore (IN)

(72) Inventors: Sastry Vvr, Bangalore (IN); Jayant Bhatnagar, Bangalore (IN); Shanker A. Bhavani, Bangalore (IN); Sai Jayram Akv, Bangalore (IN); Suresh Br, Bangalore (IN); Ramanjaneya P. Reddy, Bangalore (IN); Cherukuri Vds Chowdary, Bangalore (IN)

(21) Appl. No.: 14/354,338

(22) PCT Filed: Oct. 26, 2012
(86) PCT No.: PCT/IB2012/055910

§ 371 Date: Apr. 25, 2014

(30) Foreign Application Priority Data
Oct. 27, 2011 (IN) 3682/CHE/2011

(51) Int. Cl. H04L 12/24

(52) U.S. Cl. CPC H04L 41/0654; H04Q 2213/199
USPC 370/221

(57) ABSTRACT

Embodiments of the present disclosure relate to a communication system for managing leased line networks. The system comprises of a router to route data from one network to another network, and a V.35 modem configured to receive the data from the router and transmit the data to a predefined destination using internet protocol (IP) network. The interface which connects the router with the V.35 modem is a V.35 interface. The IP network requires an ethernet interface to receive the data and to transmit the data to a destined location. The V.35 modem designed converts the V.35 interface to an ethernet interface, but since the ethernet interface is expensive, the V.35 modem converts the ethernet interface to an ADSL interface for establishing ADSL connection towards the IP network. The system further comprising an interface to 3G/LTE/Wifi which is used as a redundant path in the event of failure of ADSL interface.

### TECHNICAL FIELD

The present disclosure relates to communication network. More particularly the embodiments of the disclosure relate to a communication system for managing leased line networks with wireless fall back.

### BACKGROUND

Network architecture for managing leased line networks is shown in FIG. 1. Leased lines 100 are used to connect networks of two locations (101, 105) of an organization using a nailed up dedicated path. The dedicated path is through E1/HDSL interfaces routed through PSTN switches. The architecture comprises of a router 102, a V35 modem 104 and a PSTN exchange 106. Router 102 aggregates the IP links in an organization and puts on a V35 interface 103 of WAN port or the router 102. WAN port or the router 102 is connected to V.35 modem 104 on a V.35 interface connector 103. V35 modem 104 receives the IP data through V35 interface 103 and transmits the received data towards PSTN network 106 either on G703 (E1 interface) or HDSL interface 105. Both G703 and HDSL 105 are E1 interfaces with different line encoding standards. PSTN switch 106 is connected to the E1 interfaces to receive the IP data and routes to a different location using its own E1 network towards other end of V35 modem 104 and finally to a router 102 on the other side of the PSTN network 106.

The disadvantage with this scenario is, as the requirements of leased lines increases, the interconnecting E1 interfaces between PSTN switches in the network should also grow. This cannot happen in all scenarios because there may not be E1s available to all locations. The Operating expense (Opex) and Capital expenditure (Capex) of the leased line network is very high due to the maintenance requirement of the dedicated lines. This cost will ultimately be passed on to the user. This solution is not only expensive but also the equipment required for this solution is expensive due to volumes. Further, if the connection fails there is no backup connection in the existing system.

Hence, there exists a need for a system or architecture to solve all the above problems of providing increased connectivity and low maintenance cost.

### SUMMARY

The shortcomings of the prior art are overcome and additional advantages are provided through the provision of a method and system as described in the description.

The present disclosure solves the limitations of existing techniques by providing improved and easy access to the users for managing the network connected devices without line of sight requirement.

Additional features and advantages are realized through the techniques of the present disclosure. Other embodiments and aspects of the disclosure are described in detail herein and are considered a part of the claimed disclosure.

In one embodiment, the present disclosure provides a communication system for managing leased line networks comprising, a router to route data from one network to another network. The system includes a modem configured to receive data and transmit the data to a predefined destination using internet protocol (IP) network. The data is either from a router or an IP network. The modem includes a physical interface block to receive the data using an interface to generate predetermined data signals. The modem also includes, an ethernet processor block to receive the predetermined data signals to generate ethernet packets and an Asymmetric Digital Subscriber Line (ADSL) processor block to receive the ethernet packets to generate ADSL data. The ADSL processor block establishes communication between the modem and the internet protocol (IP) network through existing DSLAMS in PSTN network. The interface block connected to the ADSL processor block to perform at least one of transmitting the ADSL data onto the IP network and receiving data from the IP network. The ADSL signals are at least one of decrypted signals if transmitted to an IP network and encrypted signals if transmitted to a router. The modem further includes a USB interface wireless block connected to the ethernet processor block to provide wireless communication between the modem and the IP network if there is a failure in the interface block. The system also includes a power supply to provide predetermined voltage to the modem from an external power supply.

In one embodiment, the interface block comprises a USB interface block consisting of one or more USB ports to provide communication and an ADSL interface block to establish communication between the modem and the IP network using telephone lines.

In one embodiment, the interface which connects the router with the physical interface block is V.35 interface. The modem also comprises of a TDM processor block to receive data from the physical interface block to generate TDM frames. The modem supports a bandwidth up to 8 Mbps over V.35 and also supports 10/100 ethernet interface.

In one embodiment, the present disclosure provides a method of communication in a leased line network. The method includes receiving one or more data packets by a modem from a predefined source. The method also includes performing a predetermined operation on received data packets to generate predefined data signals. The predetermined operation is one of either encrypting or decrypting operation based on the predefined source, and transmitting the predefined data signals from the modem to a destination using an internet protocol (IP) network.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristic of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 illustrates a communication system for managing leased line networks, as a prior art.

FIG. 2 illustrates a communication system for managing leased line networks in accordance with an embodiment of the present disclosure.

FIG. 3 illustrates a communication system for managing leased line networks with wireless fallback in accordance with an embodiment of the present disclosure.

FIG. 4 is an exemplary block diagram of a modem in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

An exemplary embodiment of the present disclosure is a communication system for managing leased line networks. The leased line connects two locations for data telecommunication service and is a reserved circuit between two points. The leased lines can span short or long distances. They maintain a single open circuit at all times, as opposed to traditional telephone services that reuse the same lines for many different conversations through a process called switching. The leased lines are used to connect networks of two locations of an organization using a nailed up dedicated path. Also, the communication system provides wireless interface as a backup in case of failure in the wired interface. The wireless feedback is a branched port and is used in cases where the connectivity needs to be establishes on available wireless links. The wireless connection is established by using 3G, LTE, Wifi, WiMax or any other existing wireless network communication protocols. The wireless interface can be provided using any off-the-shelve modules.

FIG. 2 illustrates a system for managing leased line networks in accordance with an embodiment of the present disclosure. The system comprises of a router 102, V.35 modem 201 and an IP network 203 for transmitting data from one location to another location, as an example from location 1 (101) and location 2 (105) as shown in FIG. 2. The router 102 aggregates the data from location 1 and puts on a V.35 interface 103 of Wireless Area Network (WAN) port or the router 102. V.35 interface 103 is a high speed serial interface designed to support both higher data rates and connectivity between data terminal equipment (DTEs) over digital lines. The WAN port is connected to a V.35 modem 201 on a V.35 interface connector 103. The V.35 modem 201 takes in the data through the V.35 interface 103, which is a high level data link control (HDLC) data, i.e the HDLC protocol embeds information in the data that allows V.35 modem 201 to control data flow and correct errors. The V.35 modem 201 encapsulates the HDLC data in an ethernet MAC frame and forms an ethernet packet. The V.35 modem 201 converts the ethernet packet to Asymmetric Digital Subscriber Line (ADSL) towards the ADSL interface 202a and sends data to IP network 203 through already established ADSL connection.

The ADSL enables faster data transmission over copper telephone lines than a conventional voice band modem can provide. Further, the V.35 modem 201 performs encryption of the data for mission critical applications. The IP network 203 through the ADSL interface 202a sends the encrypted data to the V.35 modem 201. The V.35 modem 201 converts the ADSL interface 202b to the V.35 interface 103b. Further the V.35 modem 201 decrypts the received data from the IP network 203 and transmits the decrypted data to a router 102 on the other side of the IP network through the V.35 interface 103b. The router 102 routes the decrypted data to the destination location 2 105.

FIG. 3 illustrates a system for managing leased line networks using wireless interface when ADSL fails (202a, 202b), as one embodiment. The wireless interface 301 which is a branched port from V35 to Ethernet block, is used in cases where ADSL is not available. Also, the wireless interface 301 is used when connectivity has to be established on available wireless links. The wireless interface is at least one of be 3G, LTE, Wifi, wimax or any other existing wireless protocols. The wireless interface is provided using any off-the-shelve modules.

In one embodiment, the present disclosure provides a method of communication between networks of two locations. Firstly, one or more data packets are transmitted from a source location to a router 102. The router 102 routes the data packets to a V.35 modem 201 through a V.35 interface 103a. The V.35 modem 201 transmits the data packets to an IP network 203 through an ADSL interface 201. The IP network 203 requires an ethernet interface to receive the data packets from the V.35 modem 201 which is expensive and has a lot of cable pairs. Also, if the location of router 102 is far from the IP network 203, then the expenses will further more. To overcome this, the V.35 modem converts the ethernet interface to an ADSL interface. The ADSL interface 406 makes use of existing TIP/RING 409 of telephone lines. Telephone lines are more common and available at all places. In one embodiment, the V.35 modem encrypts the data packet and transmits the encrypted data packet to the IP network 203. The IP network 203 transmits the encrypted data packet to the V.35 modem 201 through the ADSL interface 202b. The V.35 modem 201 decrypts the data packets and transmits the data packets to the router 102 that is on the side of the IP network. The router 102 routes the data packets to the destined location 105. The method also includes establishing communication using a wireless interface in case of failure in the wired interface i.e. when ADSL interface fails.

FIG. 4 is an exemplary block diagram of a V.35 modem 201 with wireless feedback in leased line network, in accordance with an embodiment of the present disclosure. The V.35 modem 201 comprises of a physical interface block or a V.35 physical interface block 401, a power supply block 411, an ethernet processor block or V.35 to ethernet processor block 403, ADSL processor block or an ethernet to ADSL processor block 404, a memory block 412, a V.35 alarm block 416, a ADSL alarm block 417, a ADSL physical interface block 406, a USB interface block 405 and USB interface for ADSL fallback block 407 or USB interface wireless block. The V.35 physical interface block 401 terminates the V.35 interface from a router 102 or any other device which is a DTE. Also, the V.35 physical interface block 401 converts differential V.35 signals to singled ended Transistor-Transistor Logic (TTL) signals and vice versa. The TTL signals are then given to V.35 to ethernet processor block 403. The V.35 to ethernet processor block 403 takes in the V.35 data, which is an HDLC data from the V.35 interface block 401, encapsulates an ethernet MAC frame and forms an ethernet packet. The ethernet packet will be given to the ethernet to ADSL processor block 404.

In one embodiment, the V35 physical interface block 401 does encryption of the data for mission critical applications. The ethernet to ADSL processor block 404 is implemented using standard ADSL chip. The ethernet to ADSL processor block 404 takes in the ethernet packet from the V.35 to ethernet processor block 403 and generates an ADSL signal towards ADSL interface. In one embodiment, the ethernet to ADSL processor block 404 establishes the ADSL connection towards the IP network, performs maintenance of digital subscriber line (DSL) interface, perform Virtual Local Area Network (VLAN) tagging, and support Dynamic Host Configuration Protocol (DHCP) etc.

A VLAN is a method of creating independent logical networks within a physical network. VLAN Tagging is the practice of inserting a VLAN ID into a packet header in order to identify which VLAN the packet belongs to. More specifically, switches use the VLAN ID to determine which port(s), or interface(s), to send a broadcast packet to. DHCP is a network configuration protocol for hosts on Internet Protocol (IP) networks. The locations of an organization that are connected to IP networks must be configured before they can communicate with each other. The most essential information needed is an IP address, and a default route and routing prefix. DHCP eliminates the manual task by a network administrator. It also provides a central database of devices that are connected to the network and eliminates duplicate resource assignments.

The ethernet to ADSL processor block 404 modulates high-frequency tones for transmission to a Digital Subscriber Line Access Multiplexer (DSLAM). The ethernet to ADSL processor block receives and demodulates high-frequency tones from at least one of the DSLAM, supports voice, video and data, performs framing and line encoding, establishes the connection towards DSLAM, obtains the IP address from DNS server, provides option for firewall, provides option for VPN and VLAN tagging, performs as a router 102 between the ethernet interface and ADSL interface or as a bridge between ethernet interface and ADSL interface.

A USB interface block for ADSL fall back or USB interface wireless block 407 is provided in the communication system as one embodiment. The USB interface wireless block 407 is a branched port from V35-Ethernet block and is used in cases where ADSL interface is not available or connectivity needs to be establishes on available wireless links. The wireless interface block 407 is connected to a wireless modem 410 which uses at least one of 3G, LTE, Wifi, WiMax or any other network communication. The interface can be provided using any off-the-shelve modules.

The power supply block 411 configured in the V.35 modem takes 12V DC power from an external power adaptor and generates all required voltages in V.35 modem 201 to operate. The memory block 412 configured in the V.35 modem is interfaced to the V.35 ethernet processor block to store the software program, IP addresses, configuration parameters etc. The V.35 alarm block 416 displays various types of V.35 specific alarms. The ADSL alarm block 417 displays various types of ADSL specific alarms. An analog TIP/RING lines or TIP/RING interface for ADSL 409 are connected to ADSL physical interface block 406 to perform A/D conversion and two-four wire conversion, in one embodiment.

In one embodiment, the V35 modem includes a USB interface block to connect an external computer to the V.35 modem through the USB for configuration and settings. An ethernet interface block is a branched port from V35-Ethernet block. The interface is used in cases where ADSL is not available or when very high data rates are required. ADSL technology places a limitation on uplink data rate of 1.5 Mbps where as Ethernet can go all the way up to 100 Mbps.

In one embodiment, the V.35 modem comprises of a TDM processor block 402 or a V35 to TDM processor block 402 to receive data from the physical interface block 401 to generate TDM frames. A framer block 413 is connected to the TDM processor block 402 to receive the TDM frames and generate E1 frames.

The E1 frames are transmitted onto the IP network using at least one of HDSL interface block 414 and E1/T1 LIU block or G703 LIU interface block 415. The E1 frame formed is coded to the HDSL format by the HDSL interface block which can then be transmitted over the E1 line. The E1 frame formed in the framer block is coded to the G703 coding. G703 LIU interface block 415 puts the data onto the TIP/TRING and RTIP/RRING. Further the data is transmitted over the E1 line which can cover very long distances.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims

1. A modem for managing a leased line network comprising:
a physical interface block 401 to receive data using an interface and to generate predetermined data signals for the received data, wherein the received data is from one of a router 102 and an IP network 203;
an ethernet processor block 403 to receive the predetermined data signals to generate ethernet packets;
Asymmetric digital subscriber line (ADSL) processor block 404 to receive the ethernet packets to generate ADSL data, said ADSL processor block establishes communication between the modem and the internet protocol (IP) network;
interface block (405, 406) connected to the ADSL processor block 404 to perform at least one of transmitting the ADSL data onto the IP network 203 or receiving data from IP network 203; and
Universal Serial Bus (USB) interface wireless block 407 connected to the ethernet processor block 403 to provide wireless communication between the modem 201 and the IP network 203 during a failure of the interface block (405, 406);
wherein the ADSL data is at least one of decrypted signals if transmitted to an IP network 203 and encrypted signals if transmitted to a router 102.

2. The modem as claimed in claim 1, wherein the data is one of data from an IP network that has to be decrypted and data from a source that has to be encrypted.

3. The modem as claimed in claim 1, wherein the interface which connects the router with the physical interface block 401 is V.35 interface.

4. The modem as claimed in claim 1, wherein the predetermined signals generated by the physical interface block 401 are transistor-transistor logic like (TTL) signals.

5. The modem as claimed in claim 1 further comprises a Time Division Multiplexing (TDM) processor block 402 to receive data from the physical interface block 401 and to generate TDM frames.

6. The modem as claimed in claim 5, wherein a framer block 413 is connected to the TDM processor block 402 to receive the TDM frames and generate E1 frames, said E1 frames are transmitted onto the Public Switched Telephone Network (PSTN) network using at least one of HDSL interface block 414 or G703 interface block 415.

7. The modem as claimed in claim 1, wherein the wireless communication is provided using at least one of 2.5G, 3G, LTE, WiFi, WiMax or any other wireless technologies.

8. The modem as claimed in claim 1, wherein the interface block (405, 406) comprises:
a USB interface block 405 consisting of one or more USB ports to provide communication, and
ADSL interface block 406 to establish communication between the modem 201 and the IP network 203 using telephone lines.

9. The modem as claimed in claim 8, wherein an analog TIP/RING lines 409 are connected to the ADSL interface block 406 to transmit ADSL signals on the telephone lines

10. The modem as claimed in claim 8, wherein one of the USB port is configured to provide connection between the modem and at least one of a computer, laptop, mobile device and electronic device.

11. The modem as claimed in claim 1 further comprises of a memory block 412 interfaced with the Ethernet processor block 403 to store predetermined parameters selected from a group comprising IP address of the router, configuration parameters of the modem, one or more applications of the modem and configuration data of the modem.

12. The modem as claimed in claim 1 is configured to use at least one of ADSL, HDSL, Ethernet, and any wireless technology as a primary port for communicating data to the IP network.

13. The modem as claimed in claim 1, wherein the modem is configured any wireless technology as a secondary port for communicating data to the IP network upon determining failure in the primary port,

14. A method for managing leased line network using a modem comprising:
receiving data using an interface by a physical interface block 401 configured in the modem to generate predetermined data signals for the received data, wherein the data is either from a router 102 or an IP network 203;
receiving predetermined data signals by an ethernet processor block 304 to generate ethernet packets;
generating ADSL data by an ADSL processor block 404 upon receiving ethernet packets, wherein the ADSL processor block 404 establishes communication between the modem and the internet protocol (IP) network 203; and
performing at least one of:
transmitting the ADSL data onto the IP network 203 by an interface block (405,406) connected to the ADSL processor block 404; and
receiving the data from the IP network 202 by the interface block (306,308); and
providing wireless communication between the modem and the IP network 202 by a USB interface wireless block 407 connected to the ethernet processor block 403 during a failure of the interface block (405, 406).
